(19) United States
(12) Patent Application Publication
(10) Pub. No.: US 2010/0183389 A1
(43) Pub. Date: Jul. 22, 2010

(54) METHOD FOR CONTROLLING A DRILLING MACHINE, AND APPARATUS FOR CARRYING OUT SAID METHOD

(76) Inventor: Bruno Bisiach, Venaria (IT)

Correspondence Address: SUGHRUE MION, PLLC, 2100 PENNSYLVANIA AVENUE, N.W., SUITE 800, WASHINGTON, DC, 20037, US

(21) Appl. No.: 12/663,233

(22) PCT Filed: Jun. 5, 2008
(86) PCT No.: PCT/IB08/52212

§ 371 Date: Dec. 4, 2009

(30) Foreign Application Priority Data
Jun. 6, 2007 (IT) TO2007A000395

(51) Int. Cl. B23B 35/00; B23Q 17/09; B23B 49/00

(52) U.S. Cl. 408/1 R; 408/13; 408/2; 408/87

(57) ABSTRACT

A method of controlling a drilling machine comprising the steps of: providing a drilling machine (13); equipping said machine (13) with a tool (15); providing a workpiece (19); associating said workpiece with a support (17a, 17b); applying a load (21) to said workpiece; working said workpiece by means of said tool, the method comprising a step of measuring load variations induced by the workpiece resistance to the working. The invention also concerns an apparatus for carrying out said method.

The invention concerns a method for controlling a drilling machine and an apparatus for carrying out said method.

More precisely, the invention concerns a method for controlling a drilling machine for automated execution of precision working cycles, for instance precision drilling cycles, and an apparatus for carrying out said method.

Chipping machine tools, commonly referred to as drilling machines or drills, are known for making cylindrical holes in materials of various kinds and shapes. The tool used in drilling machines is commonly referred to as “bit” and is generally subjected to a rotary cutting motion and a translational feed motion along its longitudinal axis.

Drilling machines are used not only for making holes solid pieces, but also for carrying out, by means of suitable tools, the operations of hole widening, flaring, spot-facing, threading (in which case they are called tapping machines), boring, and so on.

Parameters determining the speed and the quality of hole execution include: the material of which the tool is made, its sharpening conditions, the cutting speed, the feed speed and the presence of a lubricant.

Among the above parameters, it is known that the tool sharpening conditions degrade with use during working. Thus, it may happen that a tool, by which workings perfectly meeting the required parameters and tolerances are initially performed, no longer enables obtaining the same result after a number of working cycles.

Since carrying out a further working cycle with the already worn tool would lead to the attainment of an unacceptable result, whereby a worked piece should possibly be rejected, it is clear that an intervention to replace the tool by a new one or sharpening the tool before carrying out a further working cycle is necessary.

In many applications, where a high quality of the execution of the hole or other workings is not required and use of even non-perfectly sharpened tools is therefore tolerated, often an empirical intervention will be sufficient, by replacing the tool after a given number of holes, for instance statistically estimated or estimated based on periodical visual evaluations of the tool conditions.

In other applications, especially in very high precision applications or in applications where the hole is drilled in very expensive materials or where a very high number of holes are drilled, so that rejection of a piece due to a working error would have serious economical consequences, it is on the contrary necessary to operate always with perfectly sharpened tools, i.e. tools whose sharpening conditions are substantially the same as the initial conditions of a new tool.

This need entails a very frequent tool replacement, even after few tens of holes or in some cases even after a few holes, with a resulting cost increase and throughput decrease.

In some fields of application, for instance in aeronautical and aerospace industry, where it is necessary to drill several thousand holes in special materials, e.g. carbon alloys or composite materials associated with a titanium layer, by means of very expensive tools, for the subsequent assembling through riveting, the procedure described above has the drawback of demanding on the one hand a very long time for carrying out the working cycles, since it is necessary to frequently stop the drilling machine in order to replace the tool, and on the other hand a very early tool replacement, in order to prevent a whole very expensive workpiece, in which a very high number of working cycles has been already performed, from being damaged even by a single operation, e.g. a low quality hole.

In this field the need is also known to drill several holes in composite materials, formed for instance of superimposed sheets. Materials of such kind include for instance pieces obtained by superimposing convex sheets, namely an external carbon sheet and an internal titanium sheet, for building aircraft fuselages. Coupling of the two sheets is carried out by riveting and thus it is necessary to previously perform drilling.

The holes to be drilled into the composite material require use of special tools capable of both drilling the hole and forming the external flare in the carbon layer for accommodating the rivet head, which has to be perfectly flush with the fuselage surface.

Due to the characteristics of the material, drilling of the carbon layer is moreover generally performed at a much higher speed than drilling of the titanium layer, typically 20,000 rpm for carbon and about 1,000 rpm for titanium. Also the feed speeds are very different, since carbon drilling is rather quick, typically of the order of at least 2,000 mm/min, and titanium drilling is rather slow, typically of the order of 50 mm/min.

Moreover, the rotation speed of the tool also changes during flaring, where it attains about 500 rpm. Actually, since in this phase the drilling bit has already partly gone out from the titanium layer, a higher flaring speed would result in the danger of melting titanium, with the consequent risk of burrs in the hole that has been just made.

Clearly, in the above application, but not only there, it is necessary to determine the optimum depth at which the rotation and feed speeds are to be changed, in such a manner that the hole in the carbon layer is drilled at the optimum speed, the speed is subsequently reduced when the titanium layer is reached, and then the speed is further reduced for the final flaring step.

Document EP 1329270 discloses a robotised apparatus that can be used for instance in aeronautical industry for drilling holes in materials of the above kind by means of a drilling machine.

Thus, it is an object of the present invention to provide a method and an apparatus for executing precision working cycles, which method and apparatus enable solving the problem of how to determine the variation in the quality of the result that has been or is being obtained, with respect to a desired quality.

It is a second object of the present invention to provide a method and an apparatus that enable determining the wear conditions of the tool, in particular of a drill bit.

It is a third object of the present invention to provide a method and an apparatus that enable replacing the tool only when its sharpening conditions no longer meet the desired requirements.

It is a fourth object of the present invention to provide a method and an apparatus that enable determining the optimum depth at which the rotation and feed speeds are to be changed during a working performed with mixed tools simultaneously carrying out two or more workings.

It is a further, but not the last, object of the present invention to provide the above method and apparatus so that they are easy and cheap to implement in drilling machines at present in use.

The above and other objects are achieved by the method and the apparatus as claimed in the appended claims.

Advantageously, thanks to the measurement of the change in the load applied to the workpiece, it is possible to determine the conditions, and hence the execution quality, of the working cycle.

Moreover, thanks to the evaluation of said load change, it is possible to determine the wear conditions of the tool, for instance a drill bit, and consequently its sharpening conditions, thus allowing replacing the tool only when this is actually necessary, e. g. for preventing attainment of low quality workings and high costs due to the early tool replacement.

Advantageously, it is also possible to carry out the method of the invention in a conventional drilling machine, even of robotised type, especially of the type used for instance in aeronautical and aerospace industry, without substantial modifications to the machine structure.

A detailed description of an exemplary embodiment of the invention will be provided below with particular reference to the accompanying drawings, in which:

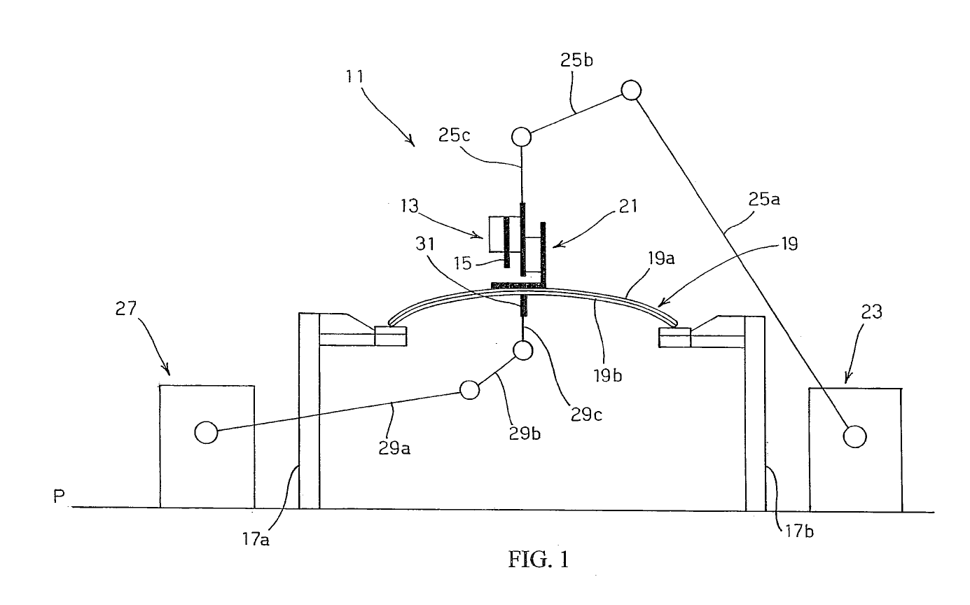

FIG. 1 is a schematic overall view of an apparatus according to the invention;

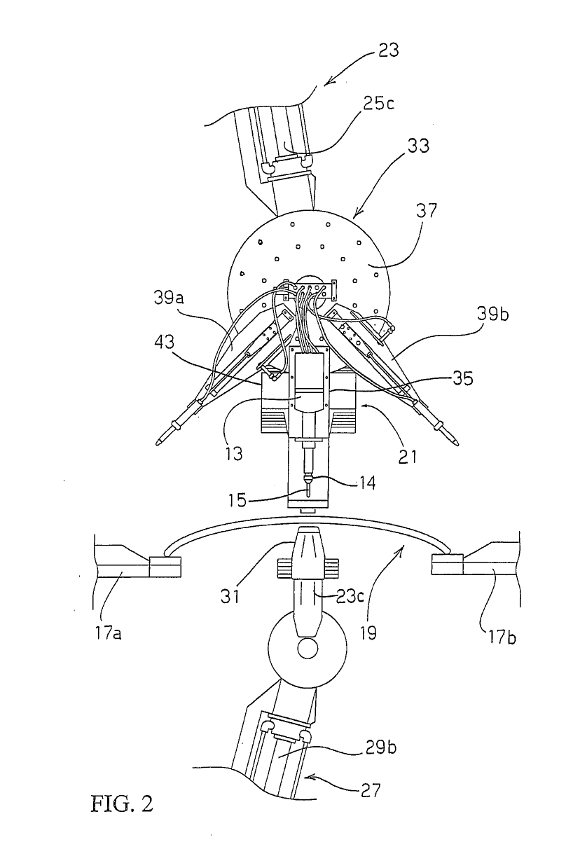

FIG. 2 is a front view of a detail of the apparatus shown in FIG. 1, according to a preferred embodiment of the invention;

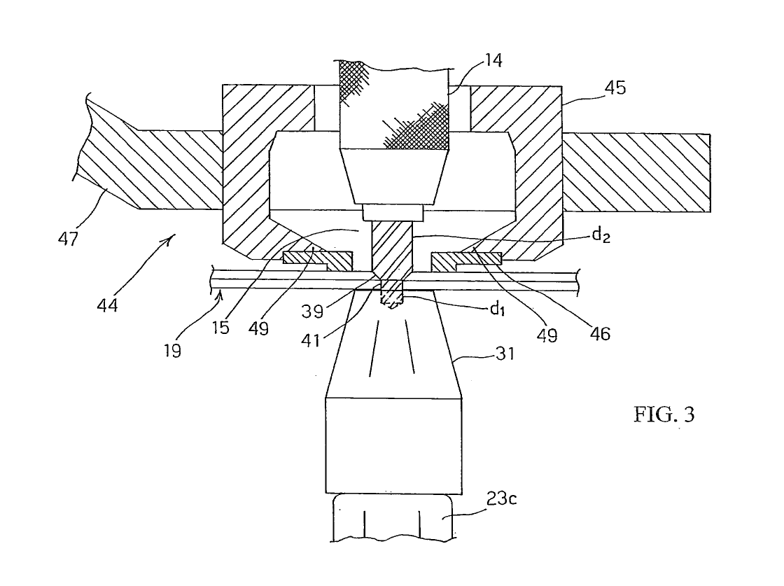

FIG. 3 is an enlarged view, partly in cross section, of a detail of the apparatus shown in FIG. 2 during a working cycle;

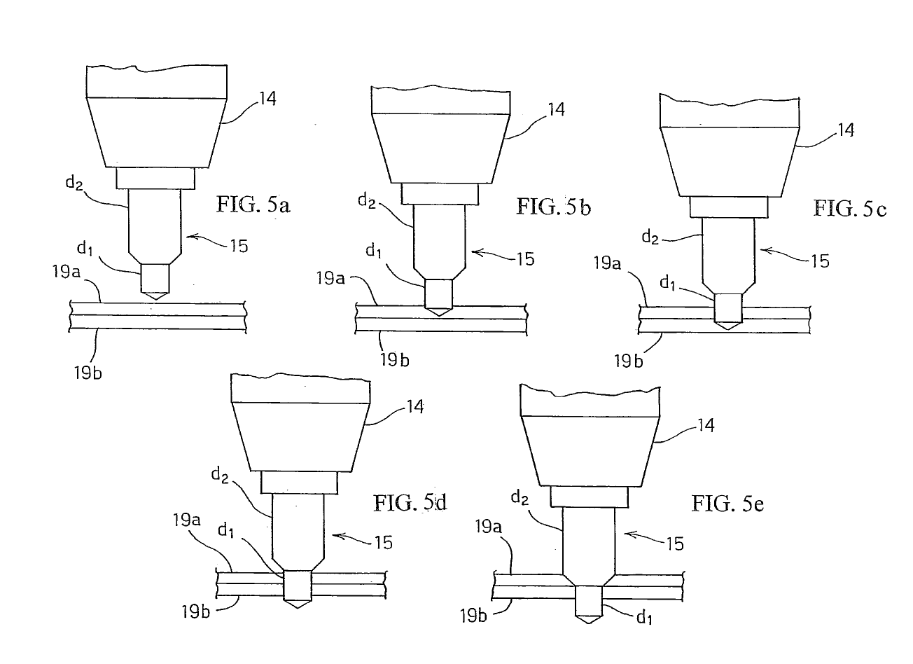

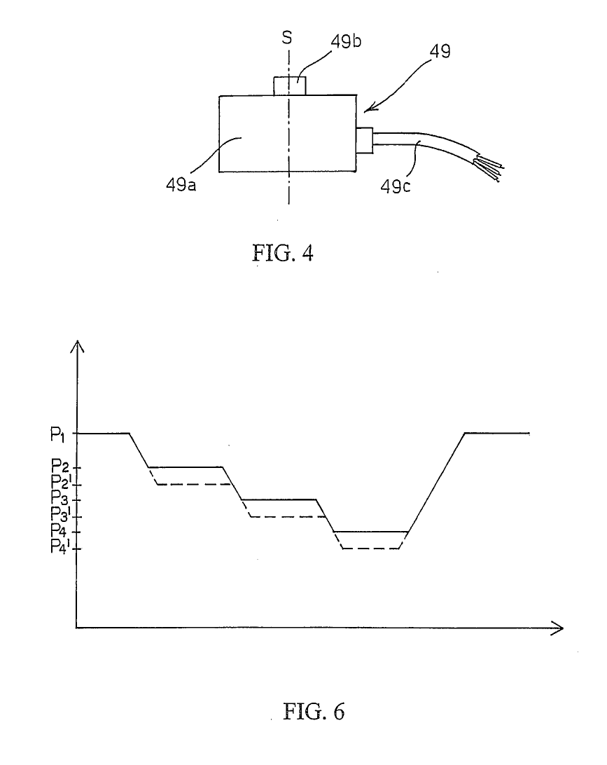

FIG. 4 is a schematic view of a load cell;

FIGS. 5a to 5e are as many schematic views of the tool position in an exemplary application;

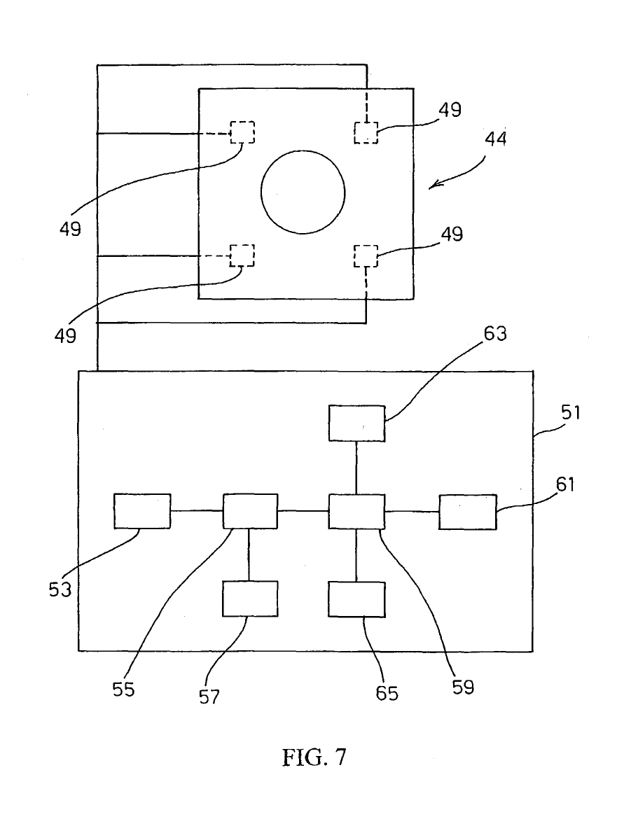

FIG. 6 is a graph of the load variation measured during working in the exemplary application of FIGS. 5a to 5d;

FIG. 7 is a schematic block diagram of the circuit processing the signal from the load cells.

Referring to FIG. 1, an apparatus 11 according to the invention is schematically shown. The apparatus comprises a drill 13 equipped with a tool 15, which in the illustrated example is a bit for simultaneous drilling and flaring, a support 17a, 17b with which a workpiece 19 is associated, and a load 21 applied to workpiece 19 to be drilled. The load is preferably arranged in correspondence of or near the area where the hole is to be drilled and on the same face of workpiece 19 as that on which tool 15 will start working.

In the illustrated example, workpiece 19 comprises, for instance, a pair of superimposed convex sheets 19a, 19b, which are to be joined by riveting after having been drilled. Said sheets, in case of aeronautical and aerospace applications, can be for instance a first, outer sheet 19a made of carbon and a second, inner sheet 19b made of titanium.

Still referring to FIG. 1, in the illustrated example, apparatus 11 according to the invention is associated with a robotised equipment comprising a first anthropomorphic robot 23 having a plurality of mutually articulated arms 25a, 25b, 25c, and a second anthropomorphic robot 27. The first robot is referred to as “outer robot” with respect to the workpiece and has associated therewith drill 13 and load 21. The second robot, which is referred to as “inner robot” with respect to the workpiece, has a plurality of mutually articulated arms 29a, 29b, 29c and has associated therewith a contrast member 31. The latter is preferably positioned by inner robot 27 in correspondence of or near the area where the hole is to be drilled and on the face of workpiece 19 opposite to that on which tool 15 will start working.

Inner and outer robots 23 and 27 are moreover firmly secured, directly or through a supporting structure that can also include guideways for the displacement of the robots relative to the workpiece and vice versa, to a floor P on which also support 17a, 17b for workpiece 19 to be drilled is supported directly or through a corresponding structure.

Turning now to FIG. 2, there is shown a preferred embodiment of the invention in which drill 13, equipped with a mandrel 14 and tool 15, is associated with head 33 of outer robot 23 by means of a first guide 35, which is slidable along a direction generally parallel to rotation axis of mandrel 14 and is preferably mounted on a revolving table 37. A set of tools 39a, 39b performing other workings, such as riveting, injection of sealing material into the hole, etc., are radially mounted on said table jointly with drill 13.

Always referring to the embodiment shown in FIG. 2, load 21 too is preferably associated with head 33 of outer robot 23, by means of a second guide 35, which is slidable along a direction preferably parallel to the sliding direction of the first guide and is also preferably mounted on revolving table 37, parallel to the first guide 35 but independently thereof, so that drill 13 and load 21 can be separately made to slide relative to table 37.

Turning now to FIG. 3, there is better shown the drilling area, where tool 15, in the illustrated example a drill bit with double diameter d1<d2, which therefore carries out also the flaring of initial portion 40 of hole 41, is located at the end of the drilling step. There, the bit is surrounded by supporting foot 44 to which load 21 is applied.

In the illustrated example, supporting foot 44 includes a centrally bored plate 45 associated with a bracket 47 mounted on guide 43, which is directly supported by the robot head or is supported through the interposition of the revolving table.

Advantageously, according to the invention, plate 45 includes a supporting member 46 associated with plate 45 through the interposition of at least one transducer device 49 capable of changing, depending on the intensity of the load to which it is subjected, at least one of the parameters into an electric signal applied to or generated by the transducer. According to the invention, four transducers 49 are provided, arranged at the corners of a square whose centre is located in correspondence of the axis of tool 15.

Transducers suitable for the purpose are for instance the so-called load cells. A load cell is actually an electronic device (transducer) used for converting a force, for instance a reaction to the thrust exerted by load 21 against workpiece 19, into an electric signal. The conversion generally takes place in two steps: through a mechanical arrangement, the force is converted into the deformation of a strain gauge, which in turn converts the mechanical deformation into an electric signal.

The load cells are in turn connected to an electronic circuit generally including also a power supply, a signal amplifier and a detecting instrument (an indicator or a recorder). Moreover, the amplified signal is generally processed by an algorithm for calculating the force applied to the transducer.

Resistive load cells (strain gauges), i.e. cells capable of changing their electric resistance depending on the applied load, are among the most widely used cells, due to their facility of use and versatility.

An example of load cell is disclosed in document U.S. Pat. No. 903,973, which discloses an axial compression load cell. By applying an electric current to the cell, the output signal has an intensity proportional to the force axially applied to the cell head.

Referring to FIG. 4, there is shown an example of a transducer 49 consisting of a load cell including a body 49a, a head 49b and an electric cable connecting the cell to the electronic control circuit which, for instance, compares the load variations with predetermined thresholds in order to determine the tool wear and/or the level of the working progress.

In the illustrated example, the load cell can be subjected to a compression in axial direction relative to control axis S, thereby obtaining a proportional variation in the electric signal.

Preferably, the cell is arranged so that axis S is parallel to the tool feed axis and hence to the axis along which the load is applied to the workpiece.

The load that can be applied to load cell like the illustrated one can be some hundred kilograms, e.g. 500 Kg, and thus such kind of device is particularly suitable for use in the apparatus according to the invention, where loads of the order of 100 Kg, for instance 130 Kg, are to be applied.

Turning to FIGS. 5a to Se, where load 21 has been removed for the sake of simplicity, the tool position is shown in the five steps of a working cycle comprising a drilling phase and a subsequent flaring phase carried out by means of a same tool onto double layer material 19.

More particularly, FIG. 5a shows tool 15 before working starts, FIG. 5b during drilling of the first layer 19a, which can be for instance of carbon or carbon-based composite material, FIG. 5c during drilling of the second layer 19b, which can be for instance of titanium or a titanium alloy, FIG. 5d at the beginning of the flaring phase and FIG. 5e at the end of the flaring phase.

Referring also to FIG. 6, the load variation measured by the load cells associated with supporting foot 44 is shown. The load applied to the workpiece before drilling starts is denoted P₁ and can be for instance about 100 Kg. During drilling of the first layer 19a (for instance of carbon) the measured load will decrease to a value P₂<P₁, because of the reaction due to the thrust for feeding tool 15 into the material of the first layer 19a.

During drilling of the second layer 19b (for instance of titanium), the measured load will change to a value P₃, which is generally different from P₂ and can be higher or lower than P₂ depending on the composition of the material of the second layer. In the example illustrated in FIG. 6, it has been assumed that the material of the second layer entails a further load reduction due to the higher resistance to the feed of tool 15, whereby P₃<P₂<P₁.

Finally, during flaring, the load attains a value P₄, which is generally different from P₂ and P₃ and depends on the composition of the material of the first layer. In the example illustrated in FIG. 6, it has been assumed that the flaring phase entails a further load reduction due to the greater resistance to the tool feed while the first layer is being flared, whereby P₄<P₃<P₂<P₁.

Advantageously, the invention is based on the principle that a variation in the force applied to the workpiece and measured by the load cells is representative of a variation in the working conditions of the tool, for instance a drilling and flaring bit like that shown for instance in FIG. 3.

Actually, if a load P₁, for instance 100 Kg, is applied to the workpiece before drilling starts, a reduction of such load to a value P₂<P₁, determined by the load applied by the drill on the bit and by the material resistance to the bit penetration, will be noticed when drilling starts.

If the bit used for drilling is perfectly sharpened and the load applied by the drill is adequate to the drilling power, such value P₂ will be little different from starting value P₁. If on the contrary the bit is worn, a sudden reduction of the load applied to the workpiece will take place, in the example even by some tens of kilograms, so that P₂′<<P₂<P₁. Similarly, values P₃′ and P₄′, respectively, taken in the subsequent working steps can be significantly different from those obtained by using a sharpened tool.

Therefore, according to the invention, the drastic reduction, or a decrease below a predetermined threshold, of the load applied to the workpiece can be advantageously exploited not only for determining the current phase in the working cycle, i.e. the stage of working progress, but also to determine the wear conditions of the tool and to decide whether the tool is to be replaced before drilling the subsequent hole.

Turning now to FIG. 7, there is shown a block diagram of the circuit processing the electric signal from load cells 49.

FIG. 7 shows four load cells 49 located in correspondence of supporting foot 44.

Load cells 49 are connected to a signal processing electronic circuit 51 including: a unit 53 for computing an average of the values obtained from the individual cells, so as to obtain a single average load value (this unit is optional, since even a single load cell can be provided and, moreover, the signal can be differently processed, for instance by differently weighing the values obtained from the individual cells); a comparator 55 for comparing the average load value with predetermined thresholds, e.g. values P₂, P₃ and P₄, measured during a working cycle carried out with a new tool and stored in a storage unit 57; a control device 59 for controlling, depending of the result of the comparison, either the choice of the speed suitable for the working in progress, e.g. a speed V₁ for the first layer, V₂ for the second layer, V₃ for the flaring, in a working speed selection unit 61, or the working stop cycle in a stopping unit 63, or the tool replacement cycle in a replacement unit 65, or an alarm signal, etc.

All said units, or some of them, can also advantageously be integrated into a single electronic device, such as an electronic processor.

1.-25. (canceled)

26. A method of controlling a drilling machine, comprising the steps of:
providing a drilling machine;
equipping said machine with a tool providing a workpiece;
associating said workpiece with a support;
working said workpiece by means of said tool;
the method further comprising the following steps:
providing a supporting foot;
applying a load to said workpiece by means of said foot;
measuring the load variations induced by the workpiece resistance to the working

27. The method as claimed in claim 26, further comprising a step of measuring said load variations by means of at least one transducer associated with said foot.

28. The method as claimed in claim 27, further comprising the step of measuring said load variation by means of four transducers associated with said foot arranged at the corners of a square whose center is located in correspondence of the axis of said tool.

29. The method as claimed in claim 26, further comprising a step of applying said load in correspondence of or near the area where the hole is to be drilled and on the same face of said workpiece as that on which said tool is intended to start working

30. The method as claimed in claim 29, further comprising the step of making said foot to surround said tool.

31. The method as claimed in claim 26, further comprising the following steps:
supporting said drilling machine by a first guide along which said tool is fed during the corresponding working step of said drilling machine; and
supporting said foot by a second guide slidable along an advance direction generally parallel to an advance direction of said first guide.

32. The method as claimed in claim 26, further comprising a step of comparing said load variations with predetermined thresholds in order to perform one or more of the following steps:
determining the stage of working progress;
determining the tool wear; and
changing the tool rotation speed depending on the result of the comparison step.

33. An apparatus for controlling a drilling machine. comprising:
a drilling machine;
a tool equipping said machine;
a support associable with a workpiece;
a load;
the apparatus further comprising:
a supporting foot by means of which said load is able to be applied to said workpiece;
a device for measuring the load variations induced by the workpiece resistance to the working.

34. The apparatus as claimed in claim 33, wherein said device comprises at least one transducer associated with said foot.

35. The apparatus as claimed in claim 34, wherein said at least one transducer comprises a load cell.

36. The apparatus as claimed in claim 33, wherein said device comprises four transducers associated with said foot arranged at the corners of a square whose center is located in correspondence of the axis of said tool.

37. The apparatus as claimed in claim 33, wherein said load is intended to be applied in correspondence of or near the area where the hole is to be drilled and on the same face of said workpiece as that on which said tool is intended to start working

38. The apparatus as claimed in claim 37, wherein said foot is able to surround said tool.

39. The apparatus as claimed in claim 38, wherein said drilling machine is supported by a first guide along which said tool is able to be fed during the corresponding working step of said drilling machine; said foot being supported by a second guide slidable along an advance direction generally parallel to an advance direction of the first guide.

40. The apparatus as claimed in claim 39, wherein said supporting foot comprises a centrally bored plate able to surround said tool and associated to a bracket mounted on said second guide.

41. The apparatus as claimed in claim 40, wherein said plate comprises a supporting member and said at least one transducer interposed between said supporting member and the rest of said plate.
